(19) United States
(12) Patent Application Publication
(10) Pub. No.: US 2024/0382292 A1
(43) Pub. Date: Nov. 21, 2024

(54) PREMILL ABUTMENT COMPATIBLE WITH THE GINGIVA FORM AND APPLICATION METHOD THEREOF

(71) Applicant: SIS DENTAL IMPLANT TEKNOLOJILERI SANAYI VE TICARET LIMITED SIRKETI, IZMIR (TR)

(72) Inventor: IBRAHIM SERCE, IZMIR (TR)

(73) Assignee: SIS DENTAL IMPLANT TEKNOLOJILERI SANAYI VE TICARET LIMITED SIRKETI, IZMIR (TR)

(21) Appl. No.: 18/265,983

(22) PCT Filed: Sep. 30, 2022
(86) PCT No.: PCT/TR2022/051067

§ 371 Date: Jun. 8, 2023

(30) Foreign Application Priority Data
Jan. 10, 2022 (TR) 2022/000251

(51) Int. Cl. A61C 8/00

(52) U.S. Cl. CPC A61C 8/008

(57) ABSTRACT

A premill abutment and a method of applying the premill abutment are provided. The premill abutment is the form of the abutments used in dental implant applications before being subjected to post-measurement shaping, specifically, the portion corresponding to the gingival region has a three-dimensional shape that is fully compatible with the shape of the gingiva former used in the treatment.

### CROSS REFERENCE TO THE RELATED APPLICATIONS

This application is the national phase entry of International Application No. PCT/TR2022/051067, filed on Sep. 30, 2022, which is based upon and claims priority to Turkish Patent Application No. 2022/000251, filed on Jan. 10, 2022, the entire contents of which are incorporated herein by reference.

### TECHNICAL FIELD

The invention relates to premill abutment (block, ingot) which has an interface part compatible with the shape of the gingiva former used for the healing of the gingiva in the contour suitable for the prosthetic tooth after the osseointegration of the surgically placed implant screw with the bone during dental implant treatment, and the application method of this premill abutment.

### BACKGROUND

In dental implant applications, the crown part (which can be named as the crown, veneer, implant tooth, prosthetic tooth, etc.) defining the implant prosthesis is placed on an abutment. The abutment is placed on the implant screw located inside the gingiva and alveolar bone. Abutments are obtained by specially shaping a block structure, defined as a premill abutment (block abutment, premill ingot, etc.), to the case and the patient's dental structure before the said insertion.

The premill abutments common in the present art generally consist of a cylindrical (which may also have other three-dimensional shapes) body block and a connection part that provides the connection with the implant screw. The connection part is in the form of a pin located under the bottom of the cylindrical body and can enter the cavity within the implant screw (allowing the abutment to be inserted). In this context, all portions of the premill abutments of the present art are subjected to case-specific shaping for implant application from the bottom to the ceiling (including all portions on the connection part and parts in contact with the gingiva).

In the present art, an implant application is performed as follows:
The implant screw is inserted into the gingiva and alveolar bone.
While waiting for osseointegration of the implant screw with the bone, the cavity of the implant screw is closed with the closing screw.
When the osseointegration of the implant screw with the bone takes place, the closing screw is removed and a gingiva former is attached instead to align and heal the gingival contours.
After the gingival healing is achieved, the gingiva former is removed and the measurement process is started by replacing it with a scanbody or measurement post.
If the measurement procedures are to be performed digitally, scanning is performed by attaching the scanbody, if it is to be performed with the classical method (measuring spoon), the procedure is performed by attaching the measurement post (transfer piece and analog).
The model is created according to the measured size.
By designing the abutment according to the model, the entire body block of the premill abutment is shaped according to the design.
The shaped abutment is placed on the implant screw.

This application in the present art has some difficulties and disadvantages.

First of all, it would be useful to make the definitions of the two parts in the current art.

Gingiva former: These are the parts that are attached for alignment and adjustment of gingival contours before abutment after the implant screw is surgically placed and osseointegrated with the bone. The gingiva formed around the gingiva former is healed in a healthy way and it is ensured that the gingiva is given the desired width of a contour before the permanent denture is inserted.

Measurement post: It is used to transfer the implants in the mouth to the model together with their correct positions during the implant prosthesis stage. Copy implants called analogs are attached to the measurements taken with the measurement post placed on the implant screw and a plaster model is obtained.

In the current art, after removing the gingiva former for the measurement process, the piece called the measurement post (scanbody, transfer part, etc.) is attached to the implant screw. This removing-inserting process, and especially the contact of the measuring skin with the newly healed gingiva, increase the risk of gingival irritation and bleeding, causing the patient to suffer.

One of the problems frequently encountered in the current art is that the diameter that occurs after the gingiva former is removed and the diameter of the measurement post are not compatible with each other. For example, if the diameter of the gingiva former is 5 mm, although a 5 mm measurement post should be used, a 3.8 mm measurement post can be used due to stock problems. This causes the problem of the inability to take the correct measurements at the bone (implant) and gingival levels. Failure to take the correct measurement at the bone (implant) and gingival levels adversely affects the design of the model and causes the part of the abutment, especially corresponding to the gingiva, not to be fully compatible with the healing gingiva. This causes problems such as movement of the implant on the gingiva and pressure on the gingiva during its use.

The main reason for the abovementioned problem is that all parts of the premill abutment are subjected to the shaping process. In particular, the shaping process performed in the part corresponding to the gingiva is adversely affected by possible processing errors during the shaping process as well as incorrect measurement.

In the present art, the patent application titled “Method for producing abutment” with the publication number JP2010221034A discloses a computer-based measurement for shaping the abutment in accordance with the gap left in the gingiva by the gingiva former removed from the gingiva. Although this method aims to provide a solution for the adaptation of abutment to the healing gingiva, it adds a further measurement step (gingival cavity measurement) to implant procedures and does not eliminate the negativities caused by the measurement errors.

In the present art, the patent application titled “Healing abutment and method for producing a design of a healing abutment” with the publication number U.S. Pat. No. 10,949,575B2 discloses a conically shaped abutment structure corresponding to the gingival region. In the solution mentioned in this document, it is envisaged that the abutment will also be used as a gingiva former. This causes the restriction of the abutment structure (size, form, shape, etc.) to be left in the patient's mouth. This method does not provide a solution to every patient and every mouth structure, it only has a limited area of use.

In the present art, there is no abutment structure that is fully compatible with gingival healing and thus eliminates the negativities that occur in standard treatment but can be applied without restricting standard treatment.

### SUMMARY

A possible embodiment of the invention is characterized in that the portion of the premill abutment corresponding to the gingival region has a geometry (three-dimensional shape) that is fully compatible with the shape of the gingiva former used in the treatment.

Another possible embodiment of the invention is characterized in that measurement can be taken by attaching the measurement post without removing the gingiva former in the implant application process steps thanks to the abovementioned premill abutment geometry. During this process, only the measurement post is placed in the cavity of the screw by removing the screw on the gingiva former (holding the gingiva former).

The invention brings the following advantages to the present art thanks to the abovementioned features.

Since the part of the premill abutment corresponding to the gingival region has a three-dimensional shape that is fully compatible with the shape of the gingiva former used in the treatment, it is ensured that the abutment attached to the implant complies with the form of the healing contour (cavity) formed by the gingiva former in the gingiva without any additional shaping process in this part. Thus, the problems that may occur in the most important region of the abutment in contact with the gingiva were eliminated.

The full compliance with the gingiva healing contour created by the gingiva former increases the performance of the abutment in the patient's mouth and eliminates the risks of infection such as pressing on the gingiva, leaving a gap between and moving.

Thanks to the structure of the premill abutment of the invention, there is no need to perform any shaping with the CNC machine for the part of the abutment that touches the gingiva. Thus, since the shaping process will be performed away from the connection part of the premill abutment to the implant screw, the possibility of damage to this area will be reduced. Since shaping will only be done for the upper region, problems related to precision arising from the machines and the shaping process have been eliminated. In addition, an important solution has been introduced for a region that is the most difficult in terms of shaping and takes the most time.

Thanks to the structure of the premill abutment of the invention, the need to remove the gingiva former in the process step of taking measurements in the implant application method has disappeared. Thanks to the exact compliance of the portion of premill abutment corresponding to the gingiva with the gingiva former used in the treatment, no additional shaping will be performed for that portion, so measurement is not required. In this context, thanks to the invention, it is possible to take measurements over the gingiva former by attaching a measurement post on the gingiva former. Thus, measurement errors regarding the diameter differences between the measurement post and the gingiva former (and hence the gap of the gingiva former) are eliminated. In addition, the insertion of the measurement post on the newly healed sensitive gingiva and the negative effects that may occur due to this disrupt the treatment comfort have been eliminated.

Thanks to the invention, the measurement post (as a scanbody in the digital process) can be used both in the measurement process with the classical method (measuring spoon and silicone) and in the digital measurement process by scanning the mouth with the intraoral scanner. Accordingly, analog, which provides measurement transfer from the measurement post, can be used both in the process of preparing the model by casting plaster with the classical method and in the process of preparing the model with the printer of the measurements taken digitally from the mouth.

This invention is hereinafter described in more detail by way of illustration with the accompanying drawings. Premill abutment compatible with the gingival healing form of the invention is not limited to the forms and elements as shown in the figures in the annex of the description. The figures are presented for illustrative purposes only.

### BRIEF DESCRIPTION OF THE DRAWINGS

FIG. 1 The portion corresponding to the gingival region is a representative view of the premill abutment, which has a three-dimensional shape that exactly matches the shape of the gingiva former used in the treatment.

FIG. 2 A representative view of the measurement post placed on the gingiva former together with the gingiva former in the measuring process step in implant application.

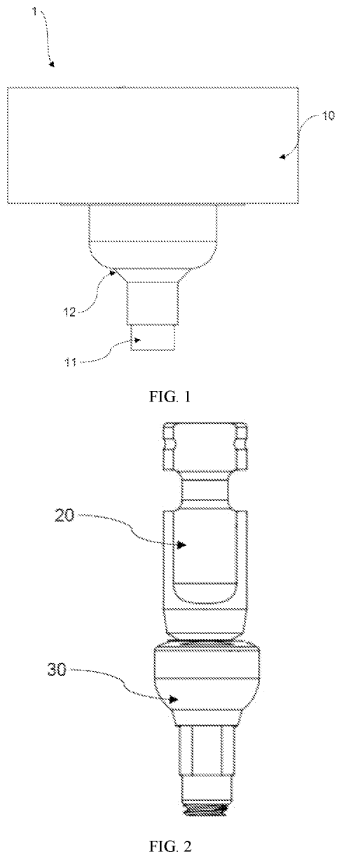

### DESCRIPTION OF THE REFERENCES

| NO | PART NAME |
|---|---|
| 1 | Premill abutment |
| 10 | Body |
| 11 | Connection part |
| 12 | Gingiva part |
| 20 | Measurement post |
| 30 | Gingiva former |

### DETAILED DESCRIPTION OF THE EMBODIMENTS

The invention may be defined as, but is not limited to, premill abutment (1) with the (three-dimensional) shape of the gingiva former (30) added to the initial form as the basic structure. Due to the invention, it can be categorized as a premill abutment (1) containing a part compatible with the shape of the cavity formed in the gingiva of the gingiva former (30). Hereinafter, it will be referred to as the gingiva part (12), as this portion corresponds to the gingival region.

This invention relates to premill abutments (1), which are the forms of the abutments used in dental implant applications before being subjected to the shaping process (shaping after the measurement process), characterized in that the part corresponding to the gingival region has a three-dimensional shape that is fully compatible with the shape of the gingiva former (30) used in the treatment. The portion having a shape fully compatible with the shape of the gingiva former (30) will be called the gingiva part (12). In other words, the said gingiva part (12) of the premill abutment (1) has a three-dimensional shape that is fully compatible with the gingiva former (30) and thus with the healed gingival cavity formed by the gingiva former (30).

The said premill abutment (1) is essentially in a monolithic form and consists of three parts. The premill abutment (1) of the invention contains the mentioned parts as the starting form. The initial form is defined as a form that has not been subjected to a forming process (before being subjected to a forming process) after the implant application. These parts are defined as the body (10), the gingiva part (12), and the connection part (11).

The connection part (11) is the element that provides the insertion of the abutment to the implant screw placed in the alveolar bone in the dental implant application. The connection part (11) is located at the end of the gingiva part (12) corresponding to the gingiva and bone side of the abutment in implant application.

The body (10) is the part of the premill abutment (1) that will be subjected to the shaping process to obtain the abutment. In the preferred embodiment of the invention, the body (10) is in the form of a cylinder block. In addition, in different versions of the invention, the body (10) structures with different three-dimensional shapes can be found. The body (10) begins at the other end of the gingiva part (12) with respect to the connection part (11). In other words, the body (10) is located on the side of the abutment to be placed on the crown (prosthetic tooth) in the implant application.

The gingiva part (12) is the part of the premill abutment (1) that has a shape that is fully compatible with the shape of the gingiva former (30) used in the treatment. It is located between the body (10) and the connection part (11). The gingiva part (12) does not need to be reshaped in practice, as it is fully compatible with the gingiva part (30). In this context, when the gingiva former (30) is removed in the implant application, thanks to the said gingiva part (12), the premill abutment (1) (hence the abutment) can be fully inserted into the gingival cavity. Thus, the negativity that occurs due to the non-compliance of the abutment with the healing gingival contours and that results in discomfort, movement, pressure, pain, bleeding and even infection is prevented.

Thanks to the said gingiva part (12), the measurement from the bone and implant level has been eliminated. Thus, it was possible to take measurements without removing the gingiva former (30).

In the preferred version of the invention, the gingiva former (30), which is suitable for inserting the measurement post (20) and includes a connection such as an abutment, is used. There is a measurement post (20) or a connection part (slot) suitable for the insertion of a scanbody on the gingiva former (30) used in the invention. The said connection slot can be closed with a separate closing screw when the measurement post (20) or the scanbody is not attached. The said closing screw may also be used as an element to secure the gingiva former (30) to the implant screw.

In dental implant application, the gingiva part (12) corresponding to the healed gingival cavity, the method of application of premill abutment (1), which has a three-dimensional shape that is fully compatible with the shape of the gingiva former (30) used in the treatment, is as follows.
The implant screw is inserted into the alveolar bone.
While waiting for osseointegration of the implant screw with the bone, the implant screw gap is closed with the closing screw.
When the osseointegration of the implant screw with the bone takes place, the closing screw is removed and the gingiva former (30) is attached instead to align and heal the gingival contours.
The measurement post (20) slot of the gingiva former (30) is closed with a closing (fixing) screw.
Measurement procedures are started by removing the closing screw and attaching the scanbody or measurement post (20) on the gingiva former (30).
Measurement is taken.
The measurement post (20) (or scanbody) is removed and the closing (fixing) screw is reinserted.
The model is created according to the size taken.
By designing the abutment according to the model, only (mostly) the body (10) part of the premill abutment (1) is shaped according to the design.
The gingiva former (30) is removed.
The shaped abutment is placed on the implant screw by means of the connection part (11).

The basic process steps of the application method of the said premill abutment (1) are as follows.
In the treatment of dental implants, a measurement is performed by attaching a scanbody or a measurement post (20) on the gingiva former (30), which is used for the alignment and healing of the gingiva contours.
The measurement post (20) (or scanbody) is removed and the closing (fixing) screw is inserted.
By making an abutment design according to the size taken, only the part of the body (10) of the premill abutment (1) is shaped.

The preferred process steps of the method of application of the said premill abutment (1) are as follows.
Performing the measurement by attaching the scanbody or measurement post (20) on the gingiva former (30) used for the alignment and healing of the gingival contours in dental implant treatment:
Removing the measurement post (20) (or scanbody);
Attaching re-closing (fastening) screw,.
Making the abutment design according to the measurement and shaping the body (10) part of the premill abutment (1),
Removing the gingiva former (30) and replacing it with the produced abutment.

Since the gingiva former (30) is not removed, comfort is provided during the procedure for the patient and the physician thanks to the invention. Precise measurement ensures that the gingiva shape can be transferred to the exact model. Measurement can be taken by both the classical method (measuring spoon) and the digital method.

Adjectives such as “upper”, “lower”, “front”, “back”, “inside”, “outside”, and “side” expressed in the description do not define a priority, direction and/or order to restrict the invention. The expressions were used in this way to better understand the embodiment of the invention.

What is claimed is:

1. A premill abutment for a use in dental implant applications, comprising a gingiva part with a three-dimensional shape, wherein the gingiva part is located in a part of the premill abutment corresponding to a healed gingival cavity and is fully compatible with a shape of a gingiva former used in a treatment.

2. The premill abutment according to claim 1, wherein the premill abutment is integral to the gingiva part and has a body part starting where the gingiva part ends and enableing the premill abutment to be obtained by shaping for a use in the treatment.

3. The premill abutment according to claim 1, wherein the premill abutment is integral with the said gingiva part and the gingiva part has a connection part located at an end corresponding to a gingiva and bone side in the dental implant applications and allows the premill abutment to be connected to an implant screw in the dental implant applications.

4. The premill abutment according to claim 3, wherein the premill abutment comprises the gingiva part in an initial form together with a body and the connection part.

5. The premill abutment according to claim 1, wherein the premill abutment comprises the gingiva part with the three-dimensional shape fully compatible with the shape of the gingiva former used in the treatment and comprises a connection part.

6. A method of applying a premill abutment, wherein at least one body part of the premill abutment is integral with a body, the premill abutment comprises a gingiva part with a three-dimensional shape fully compatible with a shape of a gingiva former starting at an end of the body and is used in a treatment, and a connection part integral with the gingiva part and located at an end corresponding to a gingiva and bone side in an implant application, wherein the method comprises process steps of:
performing a measurement by attaching a scanbody or a measurement post on the gingiva former used for an alignment and a healing gingival contours in a dental implant treatment;
removing the measurement post (or the scanbody);
attaching a re-closing (fastening) screw;
making an abutment design according to the measurement and shaping the at least one body part of the premill abutment;
removing the gingiva former and replacing the gingiva former with the premill abutment.

7. The premill abutment according to claim 2, wherein the premill abutment is integral with the gingiva part and the gingiva part has a connection part located at an end corresponding to a gingiva and bone side in the dental implant applications and allows the premill abutment to be connected to an implant screw in the dental implant applications.
